(19) United States
(12) Patent Application Publication
(10) Pub. No.: US 2011/0155332 A1
(43) Pub. Date: Jun. 30, 2011

(54) RETARDING STRUCTURE FOR ROLLING CURTAIN AND MANUFACTURING METHOD THEREOF

(75) Inventor: Ju-Huai Chen, Changhua County (TW)

(73) Assignee: MY HOME GLOBAL COMPANY, Changhua County (TW)

(21) Appl. No.: 12/651,309

(22) Filed: Dec. 31, 2009

(51) Int. Cl. E06B 9/80; B23P 11/00

(52) U.S. Cl. 160/291; 29/428

(57) ABSTRACT

In a retarding structure for rolling a curtain and a manufacturing method thereof, the retarding structure includes a housing, a shaft and an elastic element. The shaft is movably coupled into the housing, an end of the shaft is extended out from the housing; and an elastic element is sheathed onto the shaft, and both ends of the elastic element are abutted against internal walls of the housing respectively. The housing can be combined with any curtain rod having an automatic rolling mechanism, such that when a curtain fabric rolled up to the curtain rod by the automatic rolling mechanism, the shaft together with the elastic element are used to gradually increase the resistance produced during the rolling, so as to prevent the curtain fabric from rolling up instantly, and achieve the effects of preventing the curtain from being damaged easily and providing a universal application.

### FIELD OF THE INVENTION

The present invention relates to a retarding structure for rolling a curtain and a manufacturing method thereof, in particular to a structure and a method capable of preventing the curtain from being damaged and providing a universal application.

### BACKGROUND OF THE INVENTION

Traditional curtain (such as Roman curtain) generally includes a curtain rod, an elevating unit, a curtain fabric coupled to the bottom of the curtain rod, and an automatic rolling mechanism installed in the curtain rod and coupled to the curtain fabric, such that an effect of rolling up the curtain fabric automatically can be achieved.

Since the automatic rolling mechanism almost has no resistance, a larger instant rolling force will be produced when the curtain fabric is rolled up by the automatic rolling mechanism, and the curtain may be damaged easily due to excessive collisions. To overcome the aforementioned drawback, manufacturers have developed various different retarding mechanisms to prevent the curtain fabric from being rolled up instantly. However, the retarding mechanisms available in the market require an installation of the automatic rolling mechanism, such that the retarding mechanisms cannot be used in a curtain without a retarding structure, and users have to change the whole set of curtain before overcoming the problem of the curtain fabric being rolled up instantly. Obviously, the traditional retarding mechanisms provide a poor universal application and incur a waste of resources.

Therefore, it is an important subject of the present invention to provide a retarding structure for rolling a curtain and a manufacturing method thereof, so as to achieve the effects of preventing the curtain from being damaged easily and providing a universal application.

### SUMMARY OF THE INVENTION

In view of the aforementioned shortcomings of the prior art, the inventor of the present invention based on years of experience in the related industry to conduct extensive researches and experiments, and finally developed a retarding structure for rolling a curtain and a manufacturing method thereof to achieve the effects of preventing the curtain from being damaged easily and providing a universal application.

Therefore, it is a primary objective of the present invention to provide a retarding structure for rolling a curtain and a manufacturing method thereof, wherein a housing is coupled to any curtain rod having an automatic rolling mechanism, such that when a curtain fabric is rolled up to the curtain rod by the automatic rolling mechanism, the shaft together with the elastic element are provided for gradually increasing the resistance during the rolling process to prevent the curtain fabric from being rolled up instantly, so as to achieve the effects of preventing the curtain from being damaged easily and providing a universal application.

To achieve the foregoing objectives, the present invention provides a retarding structure for rolling a curtain and a manufacturing method thereof, and the structure comprises a housing, a shaft and an elastic element. When the retarding structure is manufactured, the shaft is movably coupled into the housing, such that an end of the shaft is extended out from the housing, and then the elastic element is sheathed onto the shaft, and both ends of the elastic element are abutted against internal walls of the housing respectively.

In the retarding structure for rolling a curtain and its manufacturing method in accordance with the present invention, the housing is combined with any curtain rod having an automatic rolling mechanism, such that when the curtain fabric is rolled up to the curtain rod by the automatic rolling mechanism, the shaft together with the elastic element are provided for gradually increasing the resistance during the rolling process to prevent the curtain fabric from being rolled up instantly, so as to achieve the effects of preventing the curtain from being damaged easily and providing a universal application.

### BRIEF DESCRIPTION OF THE DRAWINGS

FIG. 1 is a perspective view of the present invention;

FIG. 2 is an exploded view of the present invention;

FIG. 3 is a cross-sectional view of the present invention; and

FIG. 4 is a schematic view of an application of the present invention.

### DESCRIPTION OF THE PREFERRED EMBODIMENTS

To make it easier for the examiner to understand the objects, characteristics and effects of this invention, we use a preferred embodiment together with the attached drawings for the detailed description of the invention.

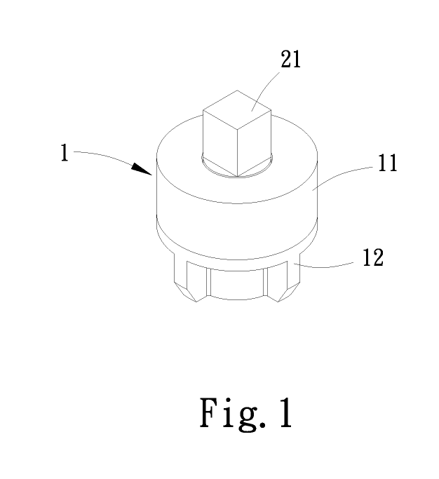

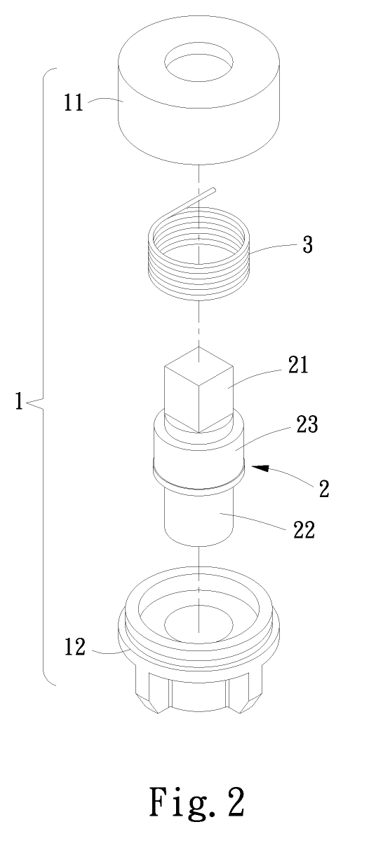

With reference to FIGS. 1 and 2 for a perspective view and an exploded view of the present invention respectively, a retarding structure for rolling a curtain and a manufacturing method thereof are disclosed, wherein the structure comprises a housing 1, a shaft 2 and an elastic element 3.

The housing 1 comprises a bushing 11, a seal cover 12 coupled to the bushing 11, and a plurality of ribs 121 formed on an external side of the seal cover 12.

The shaft 2 is movably coupled into the housing 1, wherein an end of the shaft 2 is a front-end portion 21 extended out from the bushing 11, and another end of the shaft 2 is a rear-end portion 22 disposed on an internal side of the seal cover 12, and a middle portion 23 is formed between the front-end portion 21 and the rear-end portion 22.

The elastic element 3 is a coil spring made of a metal or plastic material, and the elastic element 3 is sheathed onto the middle portion 23 of the shaft 2, and both ends of the elastic element 3 are abutted against internal walls of the bushing 11 respectively.

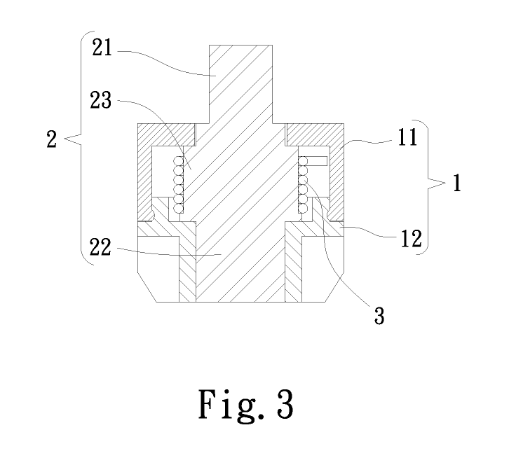

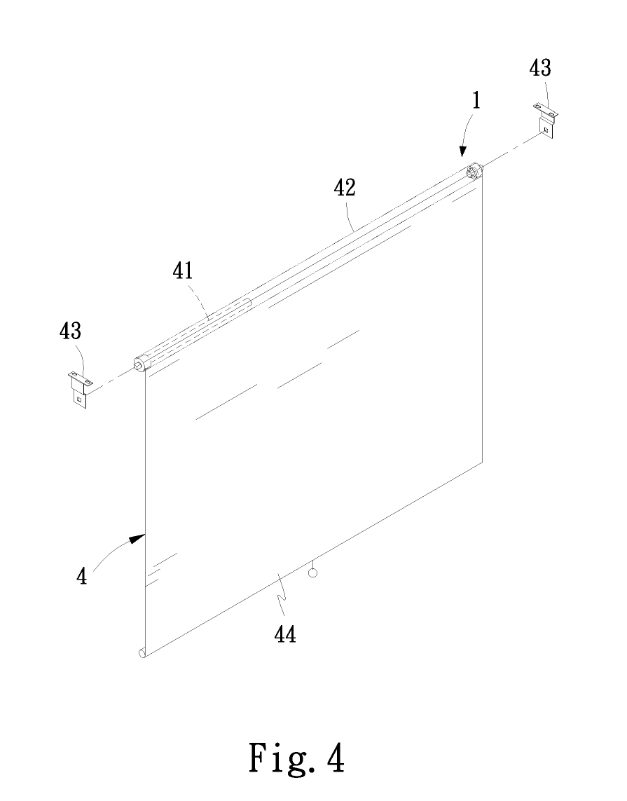

With reference to FIGS. 3 and 4 for a cross-sectional view of the present invention and a schematic view of an application of the present invention respectively, the manufacturing method of a retarding structure in accordance with the present invention comprises the following steps:

Step (a): Prepare a housing 1 having a bushing 11 and a seal cover 12.

Step (b): Install a shaft 2 into the bushing 11 of the housing 1, such that a front-end portion 21 of the shaft 2 is extended out from the bushing 11.

Step (c): Sheath an elastic element 3 onto a middle portion 23 of the shaft 2, such that both ends of an elastic element 3 are abutted against internal walls of the bushing 11 of the housing 1, and then the seal cover 12 is coupled to a distal side of the bushing 11. In addition, the front-end portion 21 of the shaft 2 is extended out from the bushing 11, and the rear-end portion 22 of the shaft 2 is disposed on an internal side of the seal cover 12, so that the shaft 2 can be movably coupled into the housing 1.

The present invention can be applied to any curtain 4 having an automatic rolling mechanism 41 (refer to FIG. 1 at the same time). When the retarding structure of the invention is installed, an external side of the seal cover 12 of the housing 1 is coupled to an end of a curtain rod 42 (and the automatic rolling mechanism 41 is situated at another end of the curtain rod 42), such that the present invention provides a better universal and practical application. When the seal cover 12 and the curtain rod 42 are installed, a plurality of ribs 121 are provided for enhancing the structural strength as well as the smoothness and engaging forces of the assembly, and then the curtain rod 41 is installed between two corresponding fixing bases 43, and the fixing base 43 is fixed at a required position to complete assembling the curtain 4. If a user rolls up a curtain fabric 44, the automatic rolling mechanism 41 will drive the curtain rod 42 to roll the curtain fabric 44, and the shaft 2 together with the elastic element 3 abutted against both internal walls of the bushing 11 are provided for gradually increasing the resistance to prevent the curtain fabric 44 from being rolled up instantly due to the resilience of the automatic rolling mechanism 41 and achieve the effect of preventing the curtain 4 from being damaged easily, when the curtain fabric 44 is rolled up.

In summation of the description above, the present invention combines the housing to any curtain rod having an automatic rolling mechanism, such that when the curtain rod uses the automatic rolling mechanism to roll up the curtain fabric, the shaft together with the elastic element gradually increase the resistance during the rolling process to prevent the curtain fabric from being rolled up instantly, so as to achieve the effects of preventing the curtain from being damaged easily and providing a universal application. In addition, products derived by the method of the invention can meet the market requirements, and the present invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A retarding structure for rolling a curtain, comprising:
a housing;
a shaft, installed in the housing, and an end of the shaft being extended out from the housing; and
an elastic element, sheathed onto the shaft, and both ends of the elastic element being abutted against internal walls of the housing respectively.

2. The retarding structure for rolling a curtain as recited in claim 1, wherein the housing comprises a bushing, a seal cover coupled to the bushing, and a plurality of ribs formed on an external side of the seal cover, and an end of the shaft is extended out from the bushing, and another end of the shaft is disposed on an internal side of the seal cover, and both ends of the elastic element are abutted against the internal walls of the housing respectively.

3. The retarding structure for rolling a curtain as recited in claim 1, wherein the shaft is movably coupled into the housing, and an end of the shaft is a front-end portion extended out from the housing, and another end of the shaft is a rear-end portion disposed on an internal side of the housing, and a middle portion is disposed between the front-end portion and the rear-end portion for sheathing the elastic element.

4. The retarding structure for rolling a curtain as recited in claim 1, wherein elastic element is made of a metal or plastic material.

5. The retarding structure for rolling a curtain as recited in claim 1, wherein the elastic element is a coil spring.

6. A manufacturing method of a retarding structure for rolling a curtain, comprising the steps of:
(a) preparing a housing;
(b) installing a shaft in the housing, such that the shaft is movably coupled into the housing and an end of the shaft is extended out from the housing; and
(c) sheathing an elastic element onto the shaft, such that both ends of the elastic element are abutted against internal walls of the housing respectively.

7. The manufacturing method of a retarding structure for rolling a curtain as recited in claim 6, wherein the housing comprises a bushing, a seal cover coupled to the bushing, and a plurality of ribs formed on an external side of the seal cover, and an end of the shaft is extended out from the bushing, and another end of the shaft is disposed on an internal side of the seal cover, and both ends of the elastic element are abutted against the internal walls of the bushing respectively.

8. The manufacturing method of a retarding structure for rolling a curtain as recited in claim 6, wherein the shaft includes a front-end portion extended from an end of the housing, a rear-end portion disposed on an internal side of the housing and extended from another end of the housing, and a middle portion disposed between the front-end portion and the rear-end portion for sheathing the elastic element.

9. The manufacturing method of a retarding structure for rolling a curtain as recited in claim 6, wherein the elastic element is a metal or plastic material.

10. The manufacturing method of a retarding structure for rolling a curtain as recited in claim 6, wherein the elastic element is a coil spring.
